(19) United States
(12) Patent Application Publication
(10) Pub. No.: US 2026/0009490 A1
(43) Pub. Date: Jan. 8, 2026

(54) METHOD AND APPARATUS FOR AN INTEGRATED PIPELINE PIGS MANUFACTURING AND LAUNCHING SYSTEM

(71) Applicant: SAUDI ARABIAN OIL COMPANY, Dhahran (SA)

(72) Inventors: Saeed Mohammed Alamoudi, Dammam (SA); Hamad Mohammed Alsharekh, Dammam (SA)

(73) Assignee: SAUDI ARABIAN OIL COMPANY, Dhahran (SA)

(21) Appl. No.: 18/764,972

(22) Filed: Jul. 5, 2024

(51) Int. Cl. F16L 55/46; F16L 55/38; F16L 55/40

(52) U.S. Cl. CPC F16L 55/46; F16L 55/38; F16L 55/40

(57) ABSTRACT

A three-stage integrated pipeline pig manufacturing and launching system for non-metallic pigs including a tail chamber configured to shape a tail end of a non-metallic pig, a molding chamber configured to produce and shape a front end of the non-metallic pig, and a launching chamber configured to launch the non-metallic pig into a pipeline. A two-stage integrated pipeline pig manufacturing and launching system for non-metallic pigs including a molding chamber configured to produce and shape a front end of the non-metallic pig using a water metering pump, and a launching chamber configured to launch the non-metallic pig into a pipeline. A two-stage integrated pipeline pig manufacturing and launching system for non-metallic pigs including a molding chamber configured to produce and shape a front end of the non-metallic pig using a piston, and a launching chamber configured to launch the non-metallic pig into a pipeline.

### BACKGROUND

Oil and gas facilities require frequent inspection to ensure integrity of equipment structures, such as downhole tubing and other pipelines. Pipeline “pigs” (pipe inspection gauges) are used to perform various cleaning, clearing, maintenance, inspection, dimensioning, process, and pipeline testing operations on new and existing pipelines. For existing pipelines, pigs are normally deployed using personnel-operated systems in remote areas, such as offshore oil and gas facilities, without stopping the flow of the product in the pipeline. Personnel-operated systems in remote areas pose both safety risks and accessibility concerns. Accordingly, there exists a need for an integrated in-situ pipeline pig system to allow for autonomous and fully remote operation of both the pig manufacturing and the launching processes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a three-stage integrated pipeline pig manufacturing and launching system for non-metallic pigs including a tail chamber, a molding chamber, and a launching chamber. The tail chamber is configured to shape a tail end of the pig using a water metering pump that is positioned at a first end of the tail chamber. The water metering pump is configured to fill the tail chamber with a known volume of water during a molding process to manipulate a diaphragm located at a second end of the tail chamber opposite the first end of the tail chamber. The diaphragm is configured to shape the tail end of the non-metallic pig and subsequently push the non-metallic pig laterally towards a molding chamber following the molding process. The molding chamber is configured to produce and shape a front end of the non-metallic pig with one or more raw material metering pumps configured to provide raw materials to the molding chamber. The molding chamber also includes a gate valve positioned at an end of the molding chamber opposite the diaphragm to shape the front end of the non-metallic pig. The launching chamber is configured to launch the non-metallic pig into a pipeline using an isolation valve, positioned in an open position during launching and a closed position during molding, in a downstream end of the launching chamber. The launching chamber further includes a vent valve configured to adjust a pressure in the launching chamber during launching.

In another aspect, embodiments disclosed herein relate to a two-stage integrated pipeline pig manufacturing and launching system for non-metallic pigs including a molding chamber and a launching chamber. The molding chamber is configured to produce and shape a front end of the non-metallic pig using one or more raw material metering pumps, a water metering pump, and a gate valve. The raw material metering pumps are configured to provide raw materials to the molding chamber to produce the non-metallic pig. The water metering pump includes a plurality of nozzles positioned at a first end of the molding chamber to push the non-metallic pig laterally towards a launching chamber following a molding process. The gate valve of the molding chamber is positioned at a second end of the molding chamber configured to shape the front end of the non-metallic pig. The launching chamber is configured to launch the non-metallic pig and includes an isolation valve and a vent valve. The isolation valve is positioned in a second end of the launching chamber and is in an open position during launching and a closed position during molding. The vent valve adjusts a pressure in the launching chamber to launch the non-metallic pig.

In another aspect, embodiments disclosed herein relate to a two-stage integrated pipeline pig manufacturing and launching system for non-metallic pigs including a molding chamber and a launching chamber. The molding chamber is configured to produce and shape a front end of the non-metallic pig using one or more raw material metering pumps, a piston, and a gate valve. The raw material metering pumps are configured to provide raw materials to the molding chamber to produce the non-metallic pig. The piston is positioned at a first end of the molding chamber to push the non-metallic pig laterally towards a launching chamber following a molding process. The gate valve of the molding chamber is positioned at a second end of the molding chamber configured to shape the front end of the non-metallic pig. The launching chamber is configured to launch the non-metallic pig and includes an isolation valve and a vent valve. The isolation valve is positioned in a second end of the launching chamber and is in an open position during launching and a closed position during molding. The vent valve adjusts a pressure in the launching chamber to launch the non-metallic pig.

Other aspects and advantages of the claimed subject matter will be apparent from the following description and the appended claims.

### BRIEF DESCRIPTION OF DRAWINGS

FIG. 1 is an illustration of a three-stage integrated pipeline pig manufacturing and launching system in accordance with one or more embodiments.

FIG. 2 is an illustration of a liquid-powered two-stage integrated pipeline pig manufacturing and launching system in accordance with one or more embodiments.

FIG. 3 is an illustration of a piston-powered two-stage integrated pipeline pig manufacturing and launching system in accordance with one or more embodiments.

FIG. 4A-4D are illustrations of a diaphragm in accordance with one or more embodiments.

FIG. 5 shows a computer system in accordance with one or more embodiments.

### DETAILED DESCRIPTION

In one aspect, embodiments disclosed herein relate to a three-stage integrated pipeline pig manufacturing and launching system for non-metallic pigs. In another aspect, embodiments disclosed herein relate to a liquid-powered two-stage integrated pipeline pig manufacturing and launching system for non-metallic pigs. In yet another aspect, embodiments disclosed herein relate to a piston-powered two-stage integrated pipeline pig manufacturing and launching system for non-metallic pigs.

Non-metallic pigs include, but are not limited to, polymer pigs, foam pigs, and dissolvable pigs. Specifically, these pipeline pigs are manufactured from one or more raw materials including, but not limited to, isocyanates, polyols, and other additives that combine to produce the pig. An example of an effective isocyanate in this application is an aromatic diisocyanate. The pipeline pig may be cylindrical with one or two rounded ends. The diameter of the pipeline pig may vary based on the size of the pipeline being serviced, typically falling in a range of 0.5 feet to 5 feet.

Implementing the integrated pipeline pig manufacturing and launching system includes two distinct stages. Initially, the pipeline pig is produced in the first stage. The production of the pipeline pig includes the addition of the one or more raw materials to form the pipeline pig. Within the first stage, which may be referred to as the production stage herein, the pipeline pig is also shaped prior to launching. Once the pipeline pig is fully formed and shaped, the pipeline pig is pushed to the launching chamber. Once the fully formed and shaped pipeline pig is out of the molding chamber and in the launching chamber, the second stage beings. In the second stage, which may be referred to as the launching stage herein, the fully formed and shaped pipeline pig with upstream process fluids is delivered to a second pipeline downstream of the integrated pipeline pig manufacturing and launching system to launch the pipeline pig into the second pipeline.

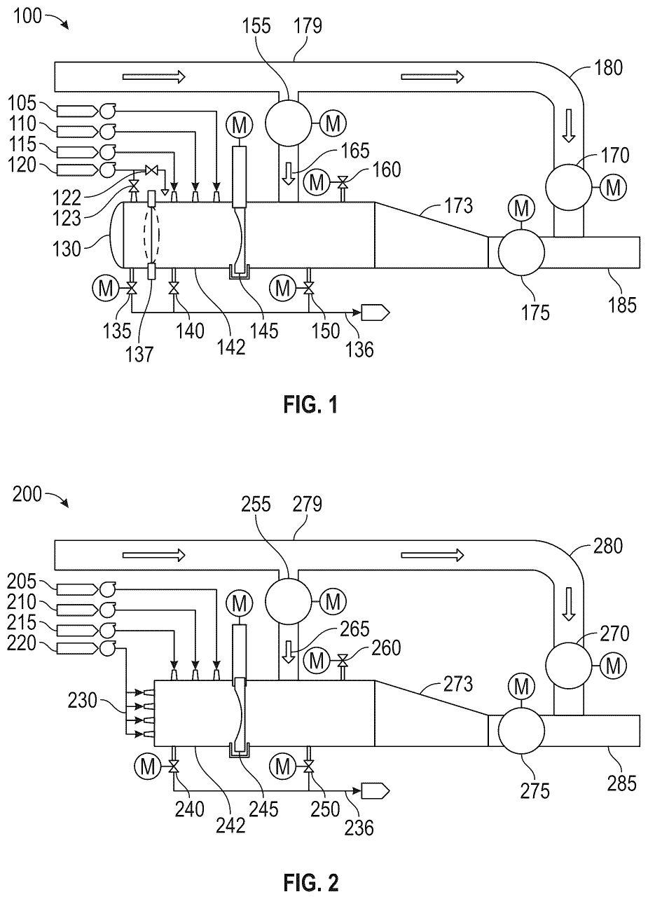

Turning to the figures, FIG. 1 is an illustration of a three-stage integrated pipeline pig manufacturing and launching system in accordance with one or more embodiments. The system 100 includes a tail chamber 130 configured to shape a tail end of the non-metallic pig. The tail chamber 130 includes a water metering pump 120, positioned at a first end of the tail chamber 130, providing water to fill the tail chamber 130 with a known volume of water during the molding process after the pipeline pig has been produced in a molding chamber 142. The water metering pump 120 feeds two lines, one to the tail chamber 130 and one to the molding chamber 142. Each of the lines includes a valve to direct water as needed. For example, there is a tail chamber water valve 123 that is open when water is added to the tail chamber 130 and there is a molding chamber water valve 122 that is open when water is added to the molding chamber 142. Adjacent to the tail chamber 130, the molding chamber 142 includes one or more raw material metering pumps (105, 110, 115) to produce the pipeline pig. In FIG. 1, these one or more raw material metering pumps include an additives pump 105, a diisocyanate pump 110, and an isocyanate pump 115. Upstream of the pumps (not shown) are storage tanks for each of the one or more raw materials. The size of the storage tank is based on system specifications such as pipeline size and required frequency of pipeline pig launching. A gate valve 145 is positioned at an end of the molding chamber 142 opposite a diaphragm 137 positioned at a second end of the tail chamber 130. Both the gate valve 145 and the diaphragm 137 are used to shape the pipeline pig. Once the pipeline pig is produced from pumping in the one or more raw materials into the molding chamber 142, water is added to the tail chamber 130 and the water pressure manipulates the diaphragm 137 positioned at the second end of the tail chamber 130. For example, when the volume of the water added is less than the volume of the tail chamber 130, the diaphragm maintains a convex shape relative to a molding chamber 142, resulting in a convex shape on the tail end of the pipeline pig. When the volume of water added is greater than the volume of the tail chamber 130, the diaphragm is pushed by the water pressure into a concave shape relative to the molding chamber 142, resulting in a concave shape on the tail end of the pipeline pig. When the volume of water added is equal to the volume of the tail chamber 130, the diaphragm is pushed by the water pressure into a flat shape relative to the molding chamber 142, resulting in a flat shape on the tail end of the pipeline pig. Once the tail end of the pipeline pig is shaped from the diaphragm, the front end of the pipeline pig is shaped by the gate valve 145, which is convex relative to the molding chamber 142, producing a convex front end of the pipeline pig.

Once the pipeline pig is shaped, the water metering pump 120 will continue to inject water to the tail chamber 130 to provide water pressure to the diaphragm 137, pushing the pig toward a launching chamber 173. Once the pipeline pig has moved partially toward the launching chamber 173, additional water may be added by the water metering pump 120 to the molding chamber 142 to continue to push the pipeline pig fully to the launching chamber 173, which is adjacent to the gate valve 145 positioned at the end of the molding chamber 142 opposite the diaphragm 137. The first stage, or the production stage, is complete, and the system proceeds to the second stage, or the launching stage.

The launching chamber 173 includes a vent valve 160 and an isolation valve 175. The vent valve 160 is configured to adjust the pressure in the launching chamber 173 during the launching stage. In one or more embodiments, the vent valve 160 opens to depressurize the launching chamber 173 to prevent restriction of the pipeline pig as it moves to the next chamber. The isolation valve 175 is positioned at a downstream end of the launching chamber 173 and opens to launch the pipeline pig. When the pipeline pig is being molded and pushed towards the launching chamber 173, the isolation valve 175 is in a closed position.

Once the pipeline pig is fully formed, molded, and pushed to the launching chamber 173, the system 100 will launch the pipeline pig into a downstream end of second pipeline 185. Pressure switches are present throughout the system 100 to determine pipeline pig location and ensure its position within each chamber. The system 100 includes an upstream pipeline 179 carrying upstream process fluids that splits into a first pipeline 165 and a second pipeline 180. The first pipeline 165 connects the upstream pipeline 179 to a first end of the launching chamber 173. There is a kicker valve 155 in the first pipeline 165 configured to provide positive pressure to launch the pipeline pig. The second pipeline 180 connects the upstream pipeline 179 to a second end of the launching chamber 173 to launch the pipeline pig into the downstream end of the second pipeline 185. There is a line valve 170 in the second pipeline 180 to control the flow of the upstream process fluids to allow for launching the pipeline pig. Pressure inside the chamber is maintained at atmospheric pressure during the pipeline pig transition period by maintaining the vent valve 160 in an opened position. To initiate the launching, the gate valve 145 closes, the vent valve 160 closes, and the kicker valve 155 opens in sequence to create a pressure gradient to assist in launching the pig. The pressure for launching may be greater than, or equal to, 100 psi.

When the pipeline pig is ready to be launched, the kicker valve 155 and the isolation valve 175 will open and the line valve 170 will close. The positive pressure provided by the kicker valve 155 pushes the pipeline pig through the opened isolation valve 175, as the upstream process fluids are provided through the opened kicker valve 155 to the launching chamber 173. The upstream process fluids continue to provide pressure to push the pipeline pig downstream out of the launching chamber 173 and through to the downstream end of the second pipeline 185.

The tail chamber 130, the molding chamber 142, and the launching chamber 173 all include a drain line 136 to remove excess fluid, including water, the one or more raw materials, and/or the upstream process fluids used to push the previous pipeline pig from the system 100. The drain line 136 includes segments exiting each of the chambers that converge together to a single line. Each of the segments includes a drain valve. The segment exiting the tail chamber 130 includes a tail chamber drain valve 135. The segment exiting the molding chamber 142 includes a molding chamber drain valve 140. The segment exiting the launching chamber 173 includes a launching chamber drain valve 150. The drain line 136 may route to a drain system, which may include a piping network with a drain tank and a drain pump (not shown).

The structure and diameters of each of the chambers may vary based on the application. In the three-stage embodiment illustrated in FIG. 1, the tail chamber 130 and the molding chamber 142 are both hollow and cylindrical. In one or more embodiments, the tail chamber 130 and the molding chamber 142 have the same diameter. The launching chamber 173 may be hollow and cylindrical in a first section that is adjacent to the gate valve 145 of the molding chamber 142. In one or more embodiments, the diameter of the first section of the launching chamber 173 and the molding chamber 142 are the same. There is a second hollow tapered section of the launching chamber 173 that connects the first section to a third section. This third section is also hollow and cylindrical, though with a smaller diameter than the first section, and is adjacent to the isolation valve 175 of the launching chamber 173. The diameter of the third section may be greater than or equal to the downstream end of the second pipeline 185. In one or more embodiments, the diameters of the tail chamber 130, the molding chamber 142, and the first section of the launching chamber 173 are larger than the diameter of the downstream end of the second pipeline 185 to ensure that adequate friction is produced between the pipeline pig and the pipe that it travels through following launching.

Turning to FIG. 2, FIG. 2 is an illustration of a liquid-powered two-stage integrated pipeline pig manufacturing and launching system in accordance with one or more embodiments. The system 200 includes a molding chamber 242 configured to produce and shape a front end of the pipeline pig. The molding chamber 242 includes a water metering pump 220 with a plurality of nozzles 230 positioned at a first end of the molding chamber 242. The plurality of nozzles 230 are configured to push the pipeline pig laterally towards a launching chamber 273 once the molding process is complete. To complete the pig production and molding process, the molding chamber 242 includes one or more raw material metering pumps (205, 210, 215) to produce the pipeline pig. In FIG. 2, these one or more raw material metering pumps include an additives pump 205, a diisocyanate pump 210, and an isocyanate pump 215. Upstream of the pumps (not shown) are storage tanks for each of the one or more raw materials. The size of the storage tank is based on system specifications such as pipeline size and required frequency of pipeline pig launching. A gate valve 245 is positioned at a second end of the molding chamber 242. The gate valve 245 is used to shape the front end of the pipeline pig. Once the pipeline pig is produced from pumping in the one or more raw materials into the molding chamber 242, the front end of the pipeline pig is shaped by the gate valve 245, which is convex relative to the molding chamber 242, producing a convex front end of the pipeline pig.

Once the pipeline pig is shaped, the water metering pump 220 will continue to inject water to the molding chamber 242 to provide water pressure, pushing the pig toward a launching chamber 273. The first stage, or the production stage, is complete, and the system proceeds to the second stage, or the launching stage.

The launching chamber 273 includes a vent valve 260 and an isolation valve 275. The vent valve 260 is configured to adjust the pressure in the launching chamber 273 during the launching stage. In one or more embodiments, the vent valve 260 opens to depressurize the launching chamber 273 to prevent restriction of the pipeline pig as it moves to the next chamber. The isolation valve 275 is positioned at a downstream end of the launching chamber 273 and opens to launch the pipeline pig. When the pipeline pig is being molded and pushed towards the launching chamber 273, the isolation valve 275 is in a closed position.

Once the pipeline pig is fully formed, molded, and pushed to the launching chamber 273, the system 200 will launch the pipeline pig into a downstream end of second pipeline 285. Pressure switches are present throughout the system 200 to determine pipeline pig location and ensure its position within each chamber. The system 200 includes an upstream pipeline 279 carrying upstream process fluids that splits into a first pipeline 265 and a second pipeline 280. The first pipeline 265 connects the upstream pipeline 279 to a first end of the launching chamber 273. There is a kicker valve 255 in the first pipeline 265 configured to provide positive pressure to launch the pipeline pig. The second pipeline 280 connects the upstream pipeline 279 to a second end of the launching chamber 273 to launch the pipeline pig into the downstream end of the second pipeline 285. There is a line valve 270 in the second pipeline 280 to control the flow of the upstream process fluids to allow for launching the pipeline pig. Pressure inside the chamber is maintained at atmospheric pressure during the pipeline pig transition period by maintaining the vent valve 260 in an opened position. To initiate the launching, the gate valve 245 closes, the vent valve 260 closes, and the kicker valve 255 opens in sequence to create a pressure gradient to assist in launching the pig. The pressure for launching may be greater than, or equal to, 100 psi.

When the pipeline pig is ready to be launched, the kicker valve 255 and the isolation valve 275 will open, and the line valve 270 will close. The positive pressure provided by the kicker valve 255 pushes the pipeline pig through the opened isolation valve 275, as the upstream process fluids are provided through the opened kicker valve 255 to the launching chamber 273. The upstream process fluids continue to provide pressure to push the pipeline pig downstream out of the launching chamber 273 and through to the downstream end of the second pipeline 285.

The molding chamber 242 and the launching chamber 273 both include a drain line 236 to remove excess fluid, including water or the one or more raw materials from the system 200. The drain line 236 includes segments exiting each of the chambers that converge together to a single line. Each of the segments includes a drain valve. The segment exiting the molding chamber 242 includes a molding chamber drain valve 240. The segment exiting the launching chamber 273 includes a launching chamber drain valve 250. The drain line 236 may route to a drain system, which may include a piping network with a drain tank and a drain pump (not shown).

The structure and diameters of each of the chambers may vary based on the application. In the two-stage embodiment illustrated in FIG. 2, the molding chamber 242 is hollow and cylindrical. The launching chamber 273 may be hollow and cylindrical in a first section that is adjacent to the gate valve 245 of the molding chamber 242. In one or more embodiments, the diameter of the first section of the launching chamber 273 and the molding chamber 242 are the same. There is a second hollow tapered section of the launching chamber 273 that connects the first section to a third section. This third section is also hollow and cylindrical, though with a smaller diameter than the first section, and is adjacent to the isolation valve 275 of the launching chamber 273. The diameter of the third section may be greater than or equal to the downstream end of the second pipeline 285. The diameters of the molding chamber 242 and the first section of the launching chamber 273 are larger than the diameter of the downstream end of the second pipeline 285 to ensure that adequate friction is produced between the pipeline pig and the pipe that it travels through following launching.

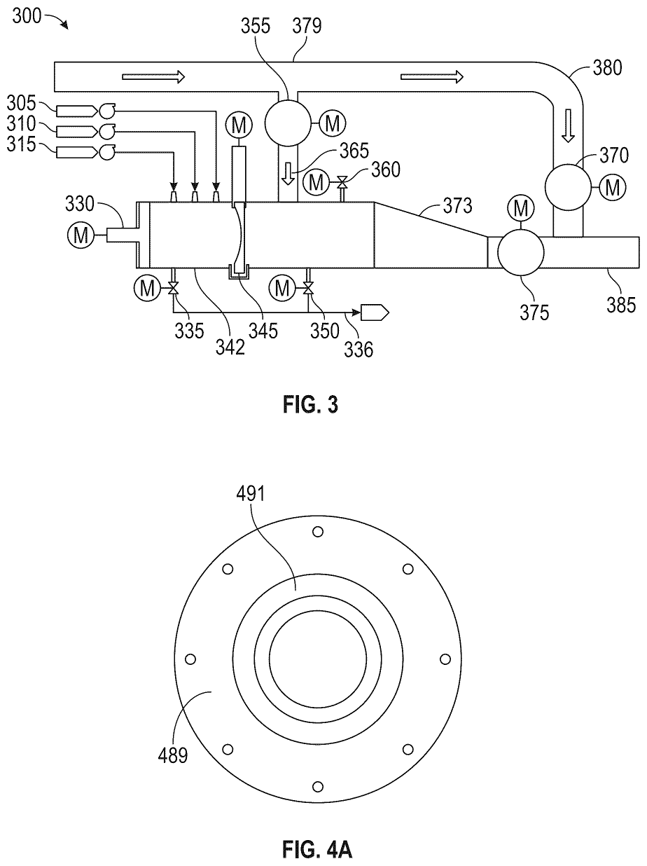

Turning to FIG. 3, FIG. 3 is an illustration of a piston-powered two-stage integrated pipeline pig manufacturing and launching system in accordance with one or more embodiments. The system 300 includes a molding chamber 342 configured to produce and shape a front end of the pipeline pig. The molding chamber 342 includes a piston 330 positioned at a first end of the molding chamber 342. The piston 330 is configured to push the pipeline pig laterally towards a launching chamber 373 once the molding process is complete. The piston 330 includes a power source to the piston. The power source may be electrical, pneumatic, or hydraulic. To complete the pig production and molding process, the molding chamber 342 includes one or more raw material metering pumps (305, 310, 315) to produce the pipeline pig. In FIG. 3, these one or more raw material metering pumps include an additives pump 305, a diisocyanate pump 310, and an isocyanate pump 315. Upstream of the pumps (not shown) are storage tanks for each of the one or more raw materials. The size of the storage tank is based on system specifications such as pipeline size and required frequency of pipeline pig launching. A gate valve 345 is positioned at a second end of the molding chamber 342. The gate valve 345 is used to shape the front end of the pipeline pig. Once the pipeline pig is produced from pumping in the one or more raw materials into the molding chamber 342, the front end of the pipeline pig is shaped by the gate valve 345, which is convex relative to the molding chamber 342, producing a convex front end of the pipeline pig.

Once the pipeline pig is shaped, the piston 330 will provide pressure, pushing the pig toward a launching chamber 373. The first stage, or the production stage, is complete, and the system proceeds to the second stage, or the launching stage.

The launching chamber 373 includes a vent valve 360 and an isolation valve 375. In one or more embodiments, the vent valve 360 opens to depressurize the launching chamber 273 to prevent restriction of the pipeline pig as it moves to the next chamber. The vent valve 360 is configured to adjust the pressure in the launching chamber 373 during the launching stage. The isolation valve 375 is positioned at a downstream end of the launching chamber 373 and opens to launch the pipeline pig. When the pipeline pig is being molded and pushed towards the launching chamber 373, the isolation valve 375 is in a closed position.

Once the pipeline pig is fully formed, molded, and pushed to the launching chamber 373, the system 300 will launch the pipeline pig into a downstream end of second pipeline 385. Pressure switches are present throughout the system 300 to determine pipeline pig location and ensure its position within each chamber. The system 300 includes an upstream pipeline 379 carrying upstream process fluids that splits into a first pipeline 365 and a second pipeline 380. The first pipeline 365 connects the upstream pipeline 379 to a first end of the launching chamber 373. There is a kicker valve 355 in the first pipeline 365 configured to provide positive pressure to launch the pipeline pig. The second pipeline 380 connects the upstream pipeline 379 to a second end of the launching chamber 373 to launch the pipeline pig into the downstream end of the second pipeline 385. There is a line valve 370 in the second pipeline 380 to control the flow of the upstream process fluids to allow for launching the pipeline pig. Pressure inside the chamber is maintained at atmospheric pressure during the pipeline pig transition period by maintaining the vent valve 360 in an opened position. To initiate the launching, the gate valve 345 closes, the vent valve 360 closes, and the kicker valve 355 opens in sequence to create a pressure gradient to assist in launching the pig. The pressure for launching may be greater than, or equal to, 100 psi.

When the pipeline pig is ready to be launched, the kicker valve 355 and the isolation valve 375 will open, and the line valve 370 will close. The positive pressure provided by the kicker valve 355 pushes the pipeline pig through the opened isolation valve 375, as the upstream process fluids are provided through the opened kicker valve 155 to the launching chamber 173. The upstream process fluids continue to provide pressure to push the pipeline pig downstream out of the launching chamber 173 and through to the downstream end of the second pipeline 385.

The molding chamber 342 and the launching chamber 373 both include a drain line 336 to remove excess fluid, including the one or more raw materials from the system 300. The drain line 336 includes segments exiting each of the chambers that converge together to a single line. Each of the segments includes a drain valve. The segment exiting the molding chamber 342 includes a molding chamber drain valve 340. The segment exiting the launching chamber 373 includes a launching chamber drain valve 350. The drain line 336 may route to a drain system, which may include a piping network with a drain tank and a drain pump (not shown).

The structure and diameters of each of the chambers may vary based on the application. In the two-stage embodiment illustrated in FIG. 3, the molding chamber 342 is hollow and cylindrical. The launching chamber 373 may be hollow and cylindrical in a first section that is adjacent to the gate valve 345 of the molding chamber 342. In one or more embodiments, the diameter of the first section of the launching chamber 373 and the molding chamber 342 are the same. There is a second hollow tapered section of the launching chamber 373 that connects the first section to a third section. This third section is also hollow and cylindrical, though with a smaller diameter than the first section, and is adjacent to the isolation valve 375 of the launching chamber 373. The diameter of the third section may be greater than or equal to the downstream end of the second pipeline 385. The diameters of the molding chamber 342 and the first section of the launching chamber 373 are larger than the diameter of the downstream end of the second pipeline 385 to ensure that adequate friction is produced between the pipeline pig and the pipe that it travels through following launching.

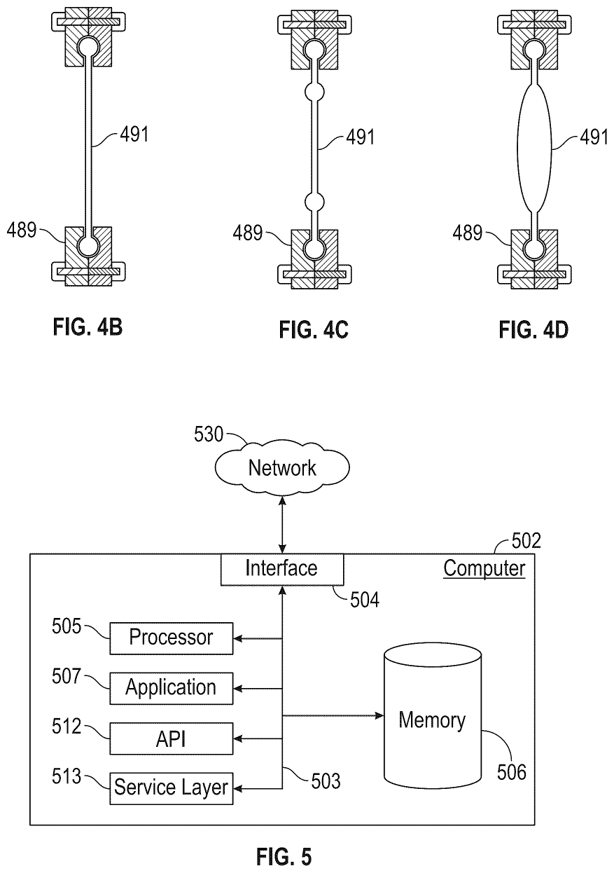

FIG. 4A-FIG. 4D illustrate the diaphragm in accordance with one or more embodiments. FIG. 4A shows a front view of the diaphragm, where an outer circular structure 489 mounts an inner circular structure 491 with a smaller diameter than the outer circular structure 489. The inner circular structure 491 is typically a flexible material and may be constructed of a material selected based on the composition of the upstream process fluids. Examples of possible materials for the inner circular structure 491 include rubber, polytetrafluoroethylene (PTFE), or thermoplastic. FIG. 4B-4D show three possible diaphragm structures. As shown, the outer edge of the diaphragm is mounted in a groove of the outer circular structure 489 surrounding the inner circular structure 491. FIG. 4B shows a flat diaphragm structure. In one or more embodiments, as shown in FIG. 4C, the inner circular structure 491 may be made up of more than one concentric circular structures which may have different thicknesses. As is shown in FIG. 4D, the diaphragm may form a dome-shape.

Each of the above-described configurations may leverage one or more of a control system, sensors, actuators, and communication modules to allow for autonomous and remote control. For example, flow rates of the water metering pump and/or the one or more raw material metering pumps may be monitored with sensors and controlled using actuators communicating with a control system. The control system may also control and actuate the gate valve, isolation valve, line valve, kicker valve, the vent valve, the tail chamber drain valve, the molding chamber drain valve, and the launching chamber drain valve based on system parameters identified through sensors and associated set points identified in the control system. Communication modules may be present to relay information between the various system components to support the control system objectives. The system may be programmed to conduct routine (for example, monthly) pipeline pig operations automatically. Additionally, raw material levels may be monitored and reported for refill.

FIG. 5 is a block diagram of a computer system 502 used to provide computational functionalities associated with described methods, functions, processes, flows, and procedures as described in the instant disclosure, according to an implementation of the control system. The illustrated computer 502 is intended to encompass any computing device such as a high performance computing (HPC) device, server, desktop computer, laptop/notebook computer, wireless data port, smart phone, personal data assistant (PDA), tablet computing device, one or more computer processors within these devices, or any other suitable processing device, including both physical or virtual instances (or both) of the computing device. Additionally, the computer 502 may include a computer that includes an input device, such as a keypad, keyboard, touch screen, or other device that can accept user information, and an output device that conveys information associated with the operation of the computer 502, including digital data, visual, or audio information (or a combination of information), or a GUI.

The computer 502 can serve in a role as a client, network component, a server, a database or other persistency, or any other component (or a combination of roles) of a computer system for performing the subject matter described in the instant disclosure. The illustrated computer 502 is communicably coupled with a network 530. In some implementations, one or more components of the computer 502 may be configured to operate within environments, including cloud-computing-based, local, global, or other environment (or a combination of environments).

At a high level, the computer 502 is an electronic computing device operable to receive, transmit, process, store, or manage data and information associated with the described subject matter. According to some implementations, the computer 502 may also include or be communicably coupled with an application server, e-mail server, web server, caching server, streaming data server, business intelligence (BI) server, or other server (or a combination of servers).

The computer 502 can receive requests over network 530 from a client application (for example, executing on another computer 502) and responding to the received requests by processing the said requests in an appropriate software application. In addition, requests may also be sent to the computer 502 from internal users (for example, from a command console or by other appropriate access method), external or third-parties, other automated applications, as well as any other appropriate entities, individuals, systems, or computers.

Each of the components of the computer 502 can communicate using a system bus 503. In some implementations, any or all of the components of the computer 502, both hardware or software (or a combination of hardware and software), may interface with each other or the interface 504 (or a combination of both) over the system bus (503) using an application programming interface (API) 512 or a service layer 513 (or a combination of the API 512 and service layer 513. The API 512 may include specifications for routines, data structures, and object classes. The API 512 may be either computer-language independent or dependent and refer to a complete interface, a single function, or even a set of APIs. The service layer 513 provides software services to the computer 502 or other components (whether or not illustrated) that are communicably coupled to the computer 502. The functionality of the computer 502 may be accessible for all service consumers using this service layer. Software services, such as those provided by the service layer 513, provide reusable, defined business functionalities through a defined interface. For example, the interface may be software written in JAVA, C++, or other suitable language providing data in extensible markup language (XML) format or other suitable format. While illustrated as an integrated component of the computer 502, alternative implementations may illustrate the API 512 or the service layer 513 as stand-alone components in relation to other components of the computer 502 or other components (whether or not illustrated) that are communicably coupled to the computer 502. Moreover, any or all parts of the API 512 or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502. The interface 504 is used by the computer 502 for communicating with other systems in a distributed environment that are connected to the network 530. Generally, the interface (504 includes logic encoded in software or hardware (or a combination of software and hardware) and operable to communicate with the network 530. More specifically, the interface 504 may include software supporting one or more communication protocols associated with communications such that the network 530 or interface's hardware is operable to communicate physical signals within and outside of the illustrated computer 502.

The computer 502 includes at least one computer processor 505. Although illustrated as a single processor 505 in FIG. 5, two or more computer processors may be used according to particular needs, desires, or particular implementations of the computer 502. Generally, the computer processor 505 executes instructions and manipulates data to perform the operations of the computer 502 and any algorithms, methods, functions, processes, flows, and procedures as described in the instant disclosure.

The computer 502 also includes a memory 506 that holds data for the computer 502 or other components (or a combination of both) that can be connected to the network 530. For example, memory 506 can be a database storing data consistent with this disclosure. Although illustrated as a single memory 506 in FIG. 5, two or more memories may be used according to particular needs, desires, or particular implementations of the computer 502 and the described functionality. While memory 506 is illustrated as an integral component of the computer 502, in alternative implementations, memory 506 can be external to the computer 502.

The application 507 is an algorithmic software engine providing functionality according to particular needs, desires, or particular implementations of the computer 502, particularly with respect to functionality described in this disclosure. For example, application 507 can serve as one or more components, modules, applications, etc. Further, although illustrated as a single application 507, the application 507 may be implemented as multiple applications 507 on the computer 502. In addition, although illustrated as integral to the computer 502, in alternative implementations, the application 507 can be external to the computer 502.

There may be any number of computers 502 associated with, or external to, a computer system containing computer 502, each computer 502 communicating over network 530. Further, the term “client,” “user,” and other appropriate terminology may be used interchangeably as appropriate without departing from the scope of this disclosure. Moreover, this disclosure contemplates that many users may use one computer 502, or that one user may use multiple computers 502.

In some embodiments, the computer 502 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, and/or function as a service (FaaS).

Embodiments of the present disclosure may provide at least one of the following advantages. The integration of a pipeline pig manufacturing and launching system allows for autonomous and remote production and deployment of pipeline pigs, reducing personnel requirements and risks. Eliminating personnel requirements also results in improved system control through instrumentation and automated controls. The three-stage configuration allows for optimized control of the production, shaping, and launching of the pipeline pig. The two-stage configuration allows for a more economic approach while still retaining high levels of control for producing, shaping, and launching the pipeline pig.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A three-stage integrated pipeline pig manufacturing and launching system for non-metallic pigs, comprising:
a tail chamber configured to shape a tail end of a non-metallic pig, the tail chamber comprising:
a water metering pump, positioned at a first end of the tail chamber, configured to fill the tail chamber with a known volume of water during a molding process to manipulate a diaphragm positioned at a second end of the tail chamber opposite the first end of the tail chamber, the diaphragm configured to shape the tail end of the non-metallic pig, and subsequently push the non-metallic pig laterally towards a molding chamber following the molding process;
wherein the molding chamber is configured to produce and shape a front end of the non-metallic pig, the molding chamber comprising:
one or more raw material metering pumps configured to provide one or more raw materials to the molding chamber to produce the non-metallic pig; and
a gate valve positioned at an end of the molding chamber opposite the diaphragm configured to shape the front end of the non-metallic pig;
a launching chamber configured to launch the non-metallic pig into a pipeline, the launching chamber comprising:
an isolation valve in a downstream end of the launching chamber, wherein the isolation valve is in an open position to launch the non-metallic pig and a closed position during the molding process; and
a vent valve configured to adjust a pressure in the launching chamber during launch of the non-metallic pig.

2. The three-stage integrated pipeline pig manufacturing and launching system of claim 1, further comprising a drain line fluidly connected to the tail chamber, the molding chamber, and the launching chamber.

3. The three-stage integrated pipeline pig manufacturing and launching system of claim 1, wherein the shape of the tail end of the non-metallic pig is concave when the known volume of water during the molding process is greater than a volume of the tail chamber.

4. The three-stage integrated pipeline pig manufacturing and launching system of claim 1, wherein the shape of the tail end of the non-metallic pig is convex when the known volume of water during the molding process is less than a volume of the tail chamber.

5. The three-stage integrated pipeline pig manufacturing and launching system of claim 1, wherein the shape of the tail end of the non-metallic pig is flat when the known volume of water during the molding process is equal to a volume of the tail chamber.

6. The three-stage integrated pipeline pig manufacturing and launching system of claim 1, wherein the one or more raw materials are selected from the group consisting of isocyanates, polyols, additives, and a combination thereof.

7. The three-stage integrated pipeline pig manufacturing and launching system of claim 1, further comprising a second water metering pump fluidly connected to the molding chamber to push the non-metallic pig laterally towards the launching chamber following the molding process.

8. The three-stage integrated pipeline pig manufacturing and launching system of claim 1, further comprising:
an upstream pipeline split into a first pipeline and a second pipeline;
a kicker valve in the first pipeline, wherein the first pipeline connects to a first end of the launching chamber, configured to provide positive pressure to launch the non-metallic pig; and
a line valve in the second pipeline configured to redirect flow of upstream process fluids towards the launching chamber, wherein the second pipeline connects to a second end of the launching chamber to receive the non-metallic pig with the upstream process fluids downstream of the launching chamber to launch the non-metallic pig and upstream process fluids into the second pipeline.

9. The three-stage integrated pipeline pig manufacturing and launching system of claim 1, further comprising one or more of a control system, sensors, actuators, and communication modules to allow for autonomous and remote control.

10. A two-stage integrated pipeline pig manufacturing and launching system for non-metallic pigs, comprising:
a molding chamber configured to produce and shape a front end of the non-metallic pig, the molding chamber comprising:
one or more raw material metering pumps configured to provide raw materials to the molding chamber to produce the non-metallic pig;
a water metering pump with a plurality of nozzles positioned at a first end of the molding chamber configured to push the non-metallic pig laterally towards a launching chamber following a molding process; and
a gate valve positioned at a second end of the molding chamber configured to shape the front end of the non-metallic pig;
a launching chamber configured to launch the non-metallic pig into a pipeline, comprising:
an isolation valve in a second end of the launching chamber configured to be in an open position to launch the non-metallic pig and a closed position during the molding process; and
a vent valve configured to adjust a pressure in the launching chamber to launch the non-metallic pig.

11. The two-stage integrated pipeline pig manufacturing and launching system of claim 10, further comprising a drain line exiting from the molding chamber and the launching chamber.

12. The two-stage integrated pipeline pig manufacturing and launching system of claim 10,
wherein the one or more raw materials are selected from the group consisting of isocyanates, polyols, additives, and a combination thereof.

13. The two-stage integrated pipeline pig manufacturing and launching system of claim 10, further comprising:
an upstream pipeline split into a first pipeline and a second pipeline;
a kicker valve in the first pipeline, wherein the first pipeline connects to a first end of the launching chamber, configured to provide positive pressure to launch the non-metallic pig; and
a line valve in the second pipeline configured to redirect flow of upstream process fluids towards the launching chamber, wherein the second pipeline connects to a second end of the launching chamber to receive the non-metallic pig with the upstream process fluids downstream of the launching chamber to launch the non-metallic pig and upstream process fluids into the second pipeline.

14. The two-stage integrated pipeline pig manufacturing and launching system of claim 10, further comprising one or more of a control system, sensors, actuators, and communication modules to allow for autonomous and remote control.

15. A two-stage integrated pipeline pig manufacturing and launching system for non-metallic pigs, comprising:
a molding chamber configured to produce and shape a front end of the non-metallic pig, comprising:
one or more raw material metering pumps configured to provide raw materials to the molding chamber to produce the non-metallic pig;
a piston positioned at a first end of the molding chamber configured to push the non-metallic pig laterally towards a launching chamber following a molding process; and
a gate valve positioned at a second end of the molding chamber configured to shape the front end of the non-metallic pig;
a launching chamber configured to launch the non-metallic pig into a pipeline, comprising:
an isolation valve in a second end of the launching chamber configured to be in an open position to launch the non-metallic pig and a closed position during the molding process; and
a vent valve configured to adjust a pressure in the launching chamber to launch the non-metallic pig.

16. The two-stage integrated pipeline pig manufacturing and launching system of claim 15, further comprising a drain line exiting from the molding chamber and the launching chamber.

17. The two-stage integrated pipeline pig manufacturing and launching system of claim 15, wherein the one or more raw materials are selected from the group consisting of isocyanates, polyols, additives, and a combination thereof.

18. The two-stage integrated pipeline pig manufacturing and launching system of claim 15, further comprising:
an upstream pipeline split into a first pipeline and a second pipeline;
a kicker valve in the first pipeline, wherein the first pipeline connects to a first end of the launching chamber, configured to provide pressure to launch the non-metallic pig; and
a line valve in the second pipeline configured to redirect flow of upstream process fluids towards the launching chamber, wherein the second pipeline connects to a second end of the launching chamber to receive the non-metallic pig with the upstream process fluids downstream of the launching chamber to launch the non-metallic pig and upstream process fluids into the second pipeline.

19. The two-stage integrated pipeline pig manufacturing and launching system of claim 15, further comprising one or more of a control system, sensors, actuators, and communication modules to allow for autonomous and remote control.

20. The two-stage integrated pipeline pig manufacturing and launching system of claim 15, wherein a power source for the piston is selected from the group consisting of electrical, pneumatic, and hydraulic power.
